(19) United States
(12) Patent Application Publication
(10) Pub. No.: US 2002/0072809 A1
(43) Pub. Date: Jun. 13, 2002

(54) Microcomputer control of physical devices

(76) Inventor: Michael Zuraw, Georgetown (CA)

Correspondence Address: Isis E. Caulder, Bereskin & Parr, 40 King Street West, Box 401, Toronto, ON, M5H 3Y2, CA

(21) Appl. No.: 09/983,492

(22) Filed: Oct. 24, 2001

Related U.S. Application Data
(60) Provisional application No. 60/242,434, filed on Oct. 24, 2000.

(51) Int. Cl. G05B 15/02; G05B 19/18; G05B 11/01

(52) U.S. Cl. 700/9; 700/19; 700/20

(57) ABSTRACT

The present invention provides a control system for controlling a physical process using personal computer running SCADA program. The software comprises a database of inputs and outputs, as well as plurality of data block types as well as calculation blocks and program blocks. The database contains addressing information about each signal, its type, conditioning and value. The control system is designed to operate within certain process parameters and is able to effect changes in operation to bring the process back to a desired condition without any manual intervention. The personal computer operates all control logic for the automation and manual control of the physical system without the need or intervention of a programmable logic controller (PLC) or any other external control devices.

This application claims priority from U.S. Provisional Patent Application No. 60/242,434 filed Oct. 24, 2000.

### FIELD OF THE INVENTION

This invention relates to automated control of physical systems and, in particular, to a microcomputer-based system for controlling physical devices.

### BACKGROUND OF THE INVENTION

Automated control of physical devices has been the goal of industry for over half a century. Simple logical control has given way to increasingly complex and sophisticated systems relying on a central processing unit (CPU).

A typical physical system includes a plurality of physical devices, such as motors, valves, pumps, meters, thermocouples, heaters, and other mechanical elements, gauges, etc. The automated control of such a system involves acquiring information from these physical devices, such as motor speed, valve positions, meter reading etc., processing the information with reference to desired process parameters and then issuing commands to one or more of the devices based on the outcome of the processing steps. The more sophisticated the processing steps can become, the more sophisticated and exacting the overall automated control system can be.

In practice, thee physical devices (valve, pump, meter, etc.) have an electric or electronic connection which are connected to a central control device either directly or via an input/output (I/O) bank which has a plurality of I/O modules, typically at least one for connection to each device. Depending on the device, the I/O signal is either an analog signal (e.g. an electrical signal measured in, say, millivolts (mV)) or a digital signal (e.g. an electronic signal representing a “1” or a “0”). The I/O bank will typically condition the signal received from the physical device before passing the data on to a central controller. For example, the I/O bank will typically convert analog signals to digital signals.

Central control in modern industrial systems is typically achieved with a programmable logic controller (PLC) unit, The PLC has a CPU which uses software known as ladder logic to create logical paths for the acquisition of data and actuation of system devices. The PLC offers a robust, industrial platform which is relatively low maintenance and insensitive to power interruptions. Ladder logic, however, offers only relatively rudimentary control of physical devices because it is generally limited to simple operations such as comparing a process parameter against a pre-determined value or another input value, turning devices ‘on’ or ‘off’, sending alarm signals, or starting a timer or other measurement means. Thus, for example, if the PLC senses a temperature has reached a pre-determined critical level, the ladder logic system may cause the PLC to sound an alarm signal to an operator, or may turn a heater off or open a cooling duct to alleviate the critical temperature condition. More complex control operations, such as incrementally adjusting the flow through a valve in response to a calculated pressure differential between two points in a system, are difficult to achieve with the PLC, and difficulty is exacerbated by the fact that PLCs are typically proprietary units which have a proprietary architecture and use proprietary code and protocol in their programming. Thus, more sophisticated programming of numerous PLCs is difficult and linking a number of systems and/or PLCs together is in some cases, practically impossible.

PLCs typically offer little in the way of human operator interaction. In recent years, however, PLCs have been given the ability to speak on a limited basis to the standard personal computer (PC) to provide a human-machine interface (HMI) which gives human operators a graphical representation of what the ladder logic is doing inside the PLC during program operation. The PC is also used in a passive role for such operations such as data logging, historical tending and the like. While a limited amount of data can be transferred from the PLC to the PC, and vice versa, to permit the operator to affect process parameters, the logical control of the control system remains with the PLC and, without access to the manufacture's proprietary software, programmability is near impossible. In any event, the PLC's reliance on ladder logic restricts the sophistication available to the programmer. Furthermore, the use of ladder logic does not permit the PLC to interface with other PC-based software applications and/or the operator's computer networks.

In its HMI role, the PC functions essentially as a graphical interface with the PLC and as a passive collector of data. Typically, to accomplish this task, the PC uses database software known as a supervisory control and data acquisition (SCADA) system. The SCADA system collects information, logs the information, and allows for sophisticated display of the information on a operator graphics terminal, such as a touch screen display. The SCADA program typically permits the PLC controller and physical system to be displayed graphically in a manner that mimics the actual physical system, which permits the operator to more easily identify with the real system.

In essence, the SCADA program is used to monitor the PLC-controlled system and provide certain control commands to the PLC. Such control command may be automatically initiated by tho SCADA program or may be initiated by the operator and passed by the SCADA program back to the PLC. Underneath the graphical display is the SCADA program which is essentially a database which can store and access data and perform calculations and operations based on that data. Data is typically stored and manipulated in a variety of data ‘blocks’ within the database. Depending on the particular SCADA program used, a number of block types are available, such as analog input blocks, digital input blocks, calculation blocks, boolean logic blocks, text label blocks, program blocks, analog output blocks and digital output blocks, to name a few. SCADA programs of this type are described in more detail in Intellution Incorporation's U.S. Pat. No. 5,179,701. As described in the '701 patent, however, the SCADA program is always used in conjunction with an “external control device”. such as a PLC, and thus the PC-based SCADA program is used only to access data, manipulate data and output data within the traditional HMI role in a PLC controlled physical system and, thus, is constrained by the limitations of the ladder-logic-based PLC system discussed above.

Accordingly, there is a need for an improved control system for physical devices which allows the computing flexibility and power of a PC platform and other microprocessor-based platforms to be more fully utilized.

### SUMMARY OF THE INVENTION

The present invention provides a control system for controlling the operation of a machine comprising a plurality of devices, said control system comprising:

(a) a supervisory control and data acquisition (SCADA) program, said SCADA program including a plurality of program blocks and a plurality of database blocks;

(b) a supplemental program;

(c) a processor, wherein said processor is adapted to execute said SCADA program, wherein said processor is adapted to execute said supplemental program, and wherein said processor is adapted for controlling operation of the devices

(d) a memory coupled to the processor for storing the SCADA program and the supplemental program;

(e) an input/output device coupled to the processor, for receiving and providing electrical signals directly to and from the devices; and

(f) said supplemental program enabling the processor to interoperate at least one program block of said SCADA program and at least one database block of said SCADA, in response to electrical signals received from the device, such that said processor can control the devices directly and without the need for an additional external control device.

In another aspect, the present invention provides a method of controlling a machine comprising a plurality of devices, using a control system that includes a processor that executes a supervisory control and data acquisition (SCADA) program which includes a plurality of program blocks and a plurality of database blocks, said method comprising the steps of:

(a) receiving electrical signals from at least one of the devices;

(b) interoperating at least one program block of said SCADA program with at least SCADA database block in response to the electrical signals received from the devices using a supplemental program stored with the SCADA program;

(c) providing electrical signals to the devices that correspond to the output of the at least one SCADA program block such that the devices can be controlled directly and without the need for an additional external control device.

### BRIEF DESCRIPTION OF THE DRAWINGS

For a better understanding of the present invention, and to show more clearly how it may be carried into effect, reference will now be made by way of example to the accompanying drawings, in which:

FIG. 1 is a schematic, view of a PLC-based control system according to the prior art;

FIG. 2 is a schematic view of a PC-based control system according to the present invention;

FIG. 3 is a schematic of a example logical chain of blocks of the control program used in the system of FIG, 2;

FIG. 4 is a schematic diagram illustrating the program modules of the supplemental programs utilized by the control program in the control system of FIG. 2;

FIG. 5 is a flowchart of the TIMER routine which is executed by the PC within the control system of FIG. 2;

FIG. 6 is a flowchart of the INTERLOCK routine which is executed by the PC, within the control system of FIG. 2;

FIG. 7 is a flowchart of the MAINTENANCE routine which is executed by the PC within the control system of FIG. 2:

FIG. 8 is a flowchart of the PROGRAM routine which is executed by the PC within the control system of FIG. 2;

FIG. 9 is a flowchart of the DIAGNOSTIC routine which is executed by the PC within the control system of FIG. 2; and

FIG. 10 is a flowchart of the HISTORICAL routine which is executed by the PC within the control system of FIG. 2.

### DETAILED DESCRIPTION OF THE PREFERRED EMBODIMENT

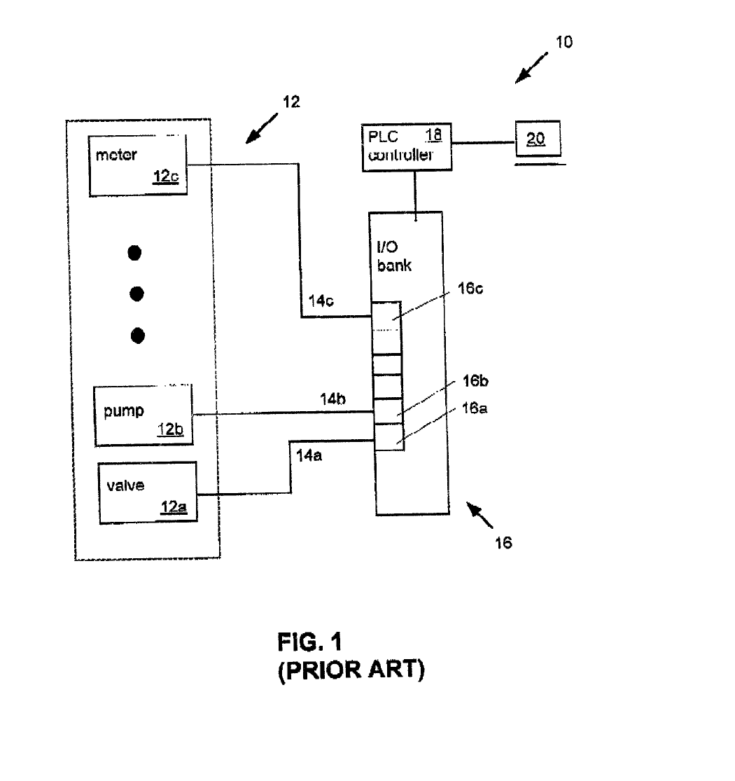

Referring to FIG. 1, a PLC-based control system according to the prior art is shown at reference numeral 10. Control system 10 is used to control the operation of a physical system 12 comprising a plurality of components such as valve 12a, pump 12b and meter 12c, connected by a plurality of signal lines 14 to an I/O bank 10 having a plurality of I/O modules 16a, 16b, 16c and so on. One skilled in the art will understand that physical system 12 may have hundreds of components and that only three such elements are shown here for ease of explanation. I/O bank 16 conditions the electronic signals received from signal lines 14 and communicates the conditioned signals to a PLC control unit 18. PLC 18, using a ladder logic-based software control system and communication protocol, monitors readings received from physical system 12 and effects command signals for return to system 12 via I/O bank 16.

Human machine interface (HMI) is provided in the form of personal computer (PC) 20 which communicates with PLC controller 18 to receive data from the PLC and log and/or display desired data to a human operator. Ladder logic control software resident on PLC controller 18 permits PLC to control physical system 12 and send certain data to PC 20 for display thereon. PC 20 performs its operation by executing a supervisory control and date acquisition (SCADA) software program such as that described in U.S. Pat. No. 5,179,701 to Intellution Incorporation, incorporated herein by reference. The '701 patent describes a system which is similar to a product marketed by Intellution Incorporation under the trade mark FIX 32. The SCADA program is described in more detail below.

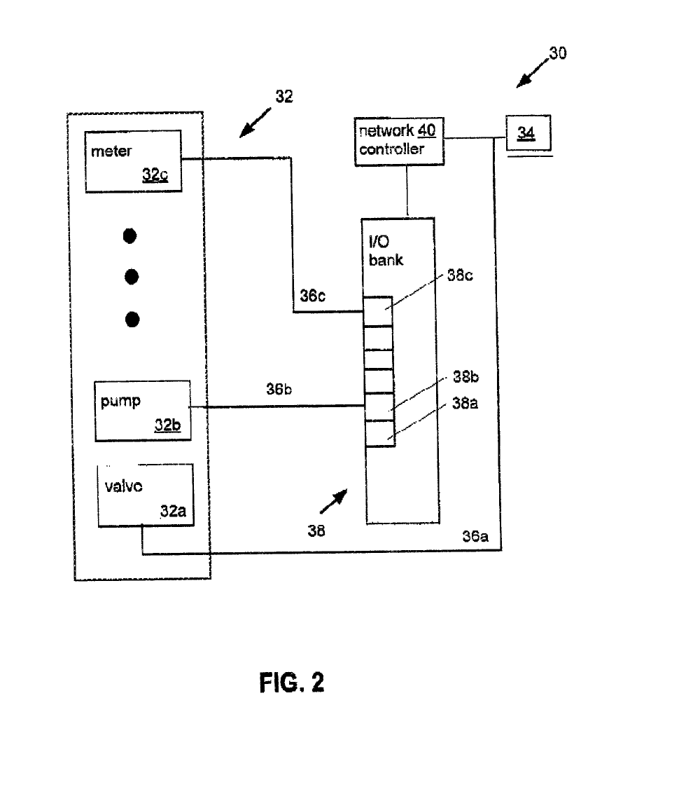

Referring to FIG. 2, a control system according to the present invention is shown at 30. Control system 30 is similar to the prior art PLC-based control system 10, in that it is used to control a physical system 32, comprised of a plurality of physical devices such as valve 32a, pump 32b and meter 32c from which electronic signals can be received and to which electronic signals can be provided. It should be understood that any physical device which is capable of sending an electronic signal based on its current operating condition or receiving a signal to affect its current operating condition may be used. Unlike the prior art PLC-based control system 10, however, the physical devices 32a, 32b and 32c can be controlled through direct communication with a microprocessor-based computer, such as a personal computer (PC) 34, via a plurality or signal lines 36a, 36b and 36c. The devices may communicate with PC 34 via an I/O bank 38 (see valve 32a and pump 32b) or may be connected directly to PC 34 (see meter 32c).

I/O bank 38 can be any conventional I/O bank product that contains a plurality of I/O modules 38a, 38b, etc, one for each input/output, and communicates with PC 34 via a network connection 40. I/O bank 38 is the same type of unit as used by the prior art control system 10. I/O bank 38 preferably accommodates both analog and digital inputs and outputs and is capable of conditioning and scaling the inputs received and outputs sent to permit full and complete communication between the physical devices 32a, 32b and 32c and PC 34. I/O bank 38 may be any type of input/output unit connectable to a personal computer, such as the preferred SNAP I/O™ board (manufactured by Opto 22, Inc. of California, U.S.A.) Alternately, an existing PLC can be modified, by disabling the ladder logic control programs to permit the PLC to tab used simply as an I/O bank, as will be described in more detail below.

PC 34 is preferably a personal computer, but it should be understood that any microprocessor-based computer capable of running the SCADA program described below may be used. It is desirable to use very stable operating system for PC 34 to provide reliable system performance for industrial application. For this reason, an operating system such as WINDOWS CE™ or WINDOWS NT™ (manufactured by Microsoft Corporation of Seattle, U.S.A.) is preferred. Other operating systems may be used however, such as UNIX, OS2, Windows 98, LINUX and Apple operating systems. Unlike the prior art PLC-based control system 10, PC 34 controls system 30 directly by using the SCADA program to monitor inputs, perform control calculations and issue output commands to the physical devices without the need for a ladder-logic system of the imposition of an external control device like a PLC.

As stated, the SCADA program of tho typo employed with the present invention is described in U.S. Pat. No. 5,179,701, which is incorporated herein by reference and thus will be described only briefly. The SCADA program permits the operator to create a spreadshoot-like database which, in essence, allows a plurality of different types of data blocks, such as input blocks, output blocks, control blocks and program blocks to be stored, scanned and manipulated according to how they are incorporated within the operational program. Within the SCADA database, each input and output device in the physical system (valve 32a, pump 32b and meter 32c) is assigned to an input and/or output data block, depending on the device and then a plurality of additional data blocks containing information about that input and/output are related to each such input/output block. In this manner, a date array is constructed containing all relevant data relating to each input and output, such as the following types of data: the signal type (e.g. analog or digital); input/output location within the I/O bank (e.g. Rack 1, Module 1); a network address assigned to the device; a label or text description of the signal (e.g. “valve”, “pump”); any signal conditioning factor to be applied to the I/O signal, an alarm state or condition for the signal; and default values for the signal on start-up, etc. Other date may also be desired or required, depending on the system or desired control program. In operation, the SCADA program periodically scans the inputs and outputs to retrieve new input values from, and to provide new output values generated by the SCADA program to, devices 32a, 32b and 32c.

Once this array has been constructed, the SCADA system is programmed according to tho control procedures desired. To do so, the variety of data manipulation blocks altered with the SCADA program are chained together logically, and programming scripting is written to interact with these logical chains, to provide system control fully within PC 34. The plurality of data manipulation blocks types available in the SCADA program described in U.S. Pat. No. 5,179,701, include proportional-integral-derivative (PID) control blocks, calculation blocks, program blocks, boolean logic blocks and other, listed in Table 1 below, and described in more detail in U.S. Pat. No. 5,179,701.

TABLE 1

| BLOCK TYPE | BLOCK TYPE |
|---|---|
| Analog alarm | On/off control |
| Analog input | Pareto |
| Analog output | PID |
| Boolean | Program |
| Calculation | Ramp |
| Digital alarm | Ratio/bias |
| Digital input | Signal select |
| Digital output | SQL data |
| Digital register | SQL trigger |
| Event action | Statistical control |
| Extended Trend | Statistical data |
| Fanout | Text |
| Histogram | Timer |
| Lead lag | Totalizer |
| Multistate digital input | Trend |

As stated, these blocks can be arranged in a logical order with the physical inputs and outputs of the system, so that one block can send its value to another block, and subsequent blocks may be linked to create a logical chain among several blocks in the databases. This feature is useful in achieving the control of devices by allowing for simultaneous monitoring of appropriate outputs and provision of appropriate inputs accordingly to desired control procedures. For example, a temperature input can be sent to a PID controller block, downstream in the logical chain, to permit the PID block to perform a PID calculation on the temperature output, to provide a resulting output control value for the system, say, a heater setting output value. The chaining of data blocks is described more particularly in U.S. Pat. No 5,179,701. In the course of creating logical chains, the program may be configured to permit a plurality of “simulated” inputs and/or outputs to be calculated and manipulated, in addition to the real, physical inputs and outputs of the system, to provide enhanced and more sophisticated control.

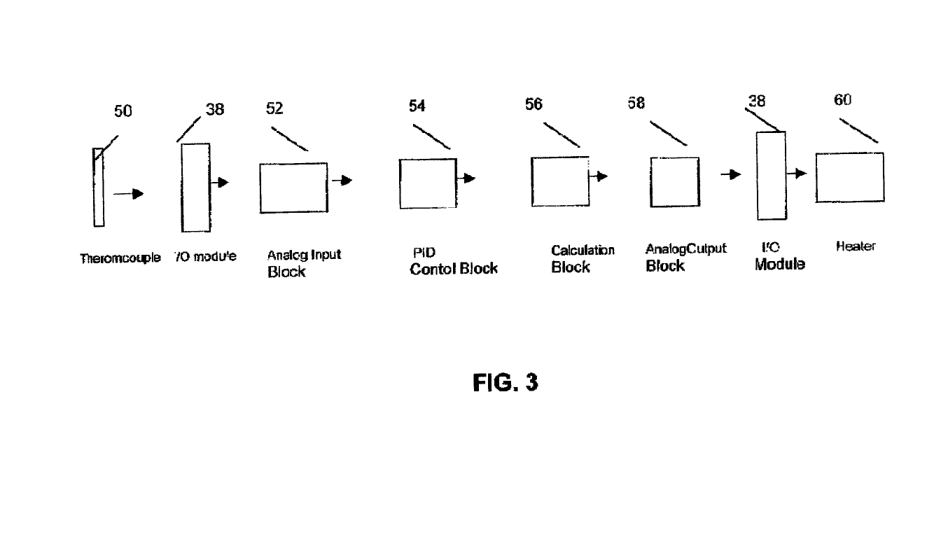

Referring now to FIG. 3, an example logical chain of blocks of the SCADA program as developed for use in association with a controlled physical system (not shown) involving a heater, coolant flow and thermocouple is illustrated.

A thermocouple 50 provides a signal to the SCADA database via an analog input I/O module in I/O bank 38 to connect to PC 34 (not shown) which is then passed to and stored within an Analog Input data block 52 in the SCADA database. The Analog Input block 52 is obtained logically upstream of a PID (proportional-integral-derivative) control block 54 which, upon receiving the thermocouple reading, performs a PID control calculation on the input signal value, then compares the input value to a set point value and, based on the comparison, sends an output value to an Analog Output block 58 downstream in a logical chain. This “output” value from the PID block 54, however, is not immediately output and is, thus, a “simulated output” to be used in a further downstream calculation or operation.

The simulated Analog Output block value is subsequently provided (in this example) to a Calculation block 56 to calculate an appropriate Analog Output value to be sent to a heater 60, and this value is then stored by PC 34 (not shown) in an Analog Output block 58. The output heater setting provided to heater 60 may be a reduced heater setting and, when the SCADA database performs its scan cycle to update inputs and outputs, this reduced-setting output value is sent to heater 60 via I/O bank 38 to heater 60 to modify its operation accordingly. Advantageously, this type of control system can permit the output of heater 60 to be gradually reduced over a calculated time period. On each scan cycle, the effect of the heater reduction can be monitored by the system, until the process is near the desired target temperature. This provides a dramatic improvement over the simple “heater off” type control available with the ladder logic systems of prior art PLC-based control systems.

The use of the intermediate products stored as “simulated” inputs/outputs permits a further flexibility in programming. For instance, in the previous example, if the simulated output, say, indicates that an upper threshold temperature has been reached in the system, a subsequent script program (discussed further below) triggered by a downstream block can determine if another system factor other than the heater is responsible. The program may, for instance, check the flow of coolant through the cooling system to determine whether this is the cause for elevated temperature. If so, the control program may choose to modify the rate of coolant flow, using the simulated output as an input to a control calculation for a flow valve or other flow regulation means in the physical system. This type of sophisticated control is not available with PLC-based systems.

As stated, the SCADA program as described in U.S. Pat. No. 5,179,701 also provides program blacks in which computer scripting language can be incorporated, thereby allowing mathematical functions and algorithms to be used to compare input values received from the I/O bank to desired values and permit the control system to act to correct any deviations. Other chains or events can then be initiated by the program blocks using many different types of conditions. For example, the database can wait for a device to reach a certain set point and, if the set point is not reached in a given period of time then a sequence of events can be put into effect by the control software. Once the device meets the required set point, then the control procedure can be continued. For example, the program block can, once executing, wait until a specified temperature input is reached and then issue a control command to the physical system to maintain that temperature for a given amount of time. Simultaneously, the program can check for any deviation in temperature ramp rate or final temperature and locate the cause of the failure by scanning the appropriate blocks, Once an error is detected, such as a heater element fault, an alarm can be issued and compensation can be made during the process to ensure the load is run properly, such as increasing the heat output or the other elements.

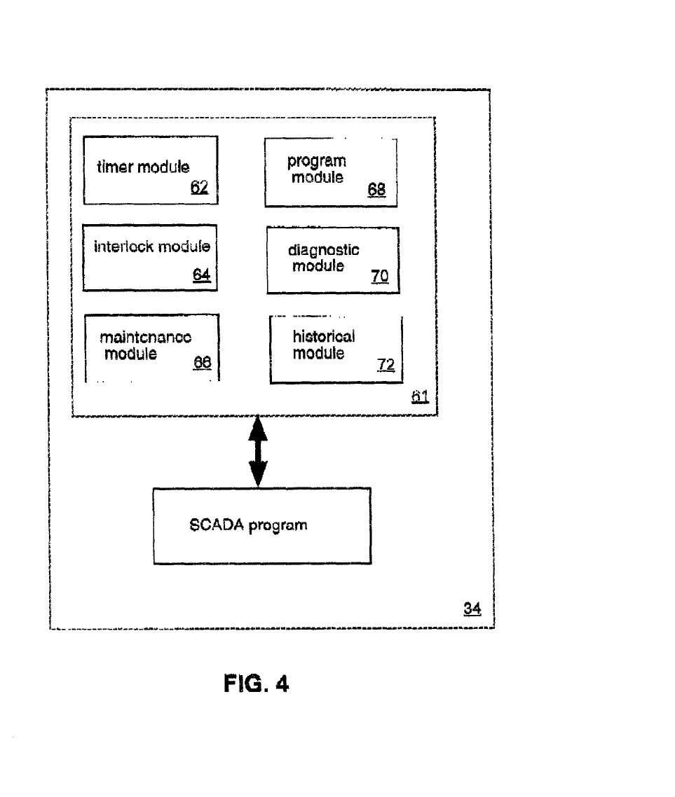

As shown in FIG. 4, PC-based control system 30 utilizes supplemental program modules 81 to ensure that the various SCADA program blocks execute on PC 34 to provide consistent and reliable control to devices 32a, 32b, and 32c directly and without the use of an external control device (e.g. PLC device). It should be understood that the SCADA program blocks and database blocks were designed to interoperate with an external control device and accordingly if an external control device is not utilized with a SCADA program, several operational problems result.

The supplemental program modules are installed alongside the SCADA program within the memory of PC 34. The supplemental program modules are adapted to interoperate with various SCADA program blocks and to provide a sufficient degree of supervision of the SCADA program such that an external control device is no longer required for proper and complete operation of the devices 32a, 32b, and 32c. Supplemental program modules include a timer module 62, an interlock module 64, a maintenance module 66, a program module 68, a diagnostic module 70, and a historical Module 72. These program modules are all interoperable with the SCADA program blocks and together achieve operational control of devices 32a, 32b, and 32c as will be described in detail below

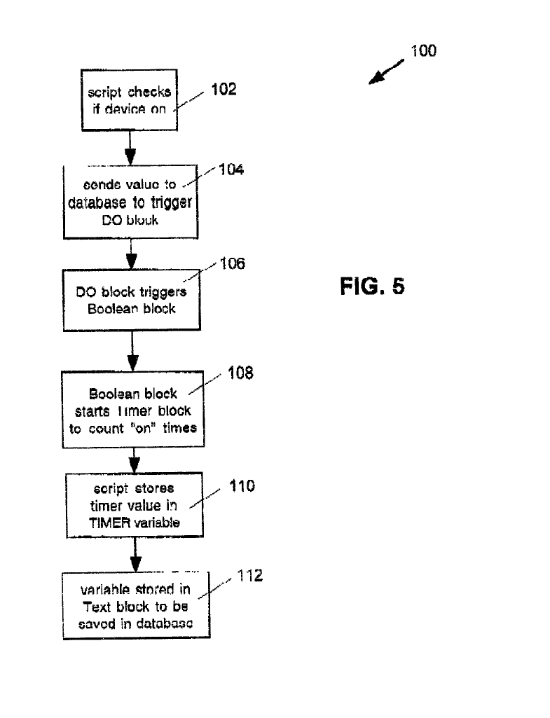

Referring now to FIGS. 2, 4, and 5, a flowchart of the TIMER routine 100 which is executed by the internal microprocessor of PC 34 when timer module 62 (FIG. 4) is utilized within control system 30 of FIG. 2, is specifically shown in FIG. 5. One of the main problems that the inventor has encountered that on continuous running, many of the reset triggers and timers and recipes do not reset upon subsequent runs. As a result, every time it was desired to run a process it was necessary to reload the database. When the database was reloaded, it was necessary to cease scanning the inputs and outputs, and to load in the default values for all program blocks and accordingly important operational information stored in the timer block would be lost (i.e. reset to default values) between runs. The timer module 62 of the supplemental program 34 was developed to address this operation limitation.

Specifically, at stop (102), the script checks to see whether the device (e.g. a pump) is on. An event in the script sends an “on” signal, or a “1” in the case of the Digital output block (DO) to start this chain of events within the timer module 62. A command in the script causes the SCADA database to send a “1” value to trigger the DO block at step (104) and in turn the DO block triggers the Boolean block at step (106). The Boolean block passes along the “1” value to start the Timer block to count the “on” time at step (108). As the time is counting, the timing data needs to be saved in the SCADA database and so the script periodically takes the timer value and puts it into a TIMER variable at step (110). The TIMER variable is then stored in a text block to be saved in the database at step (112).

Various additional routines can be built on top of the functionality of the I MER routine 100. For example, once the Timer block is started it can be programmed to count down from a predetermined set point. A set point can be downloaded from a Recipe program again by the script (not shown). Once the timer has finished counting down, the script passes the “1” value to a Quenchtrigger, which starts another chain of events (not shown). Tho script contains a loop that waits for the Quenchtrigger to have a value of “1” which is the signal to continue with the program. In this way it can be ensured that the program holds for the appropriate amount of time while a certain chain of events is accomplished. Finally, It is also possible to count the number of operational cycles by utilizing the same procedures but by counting how many times a device (e.g. a furnace) runs a program instead of “on” time as discussed above.

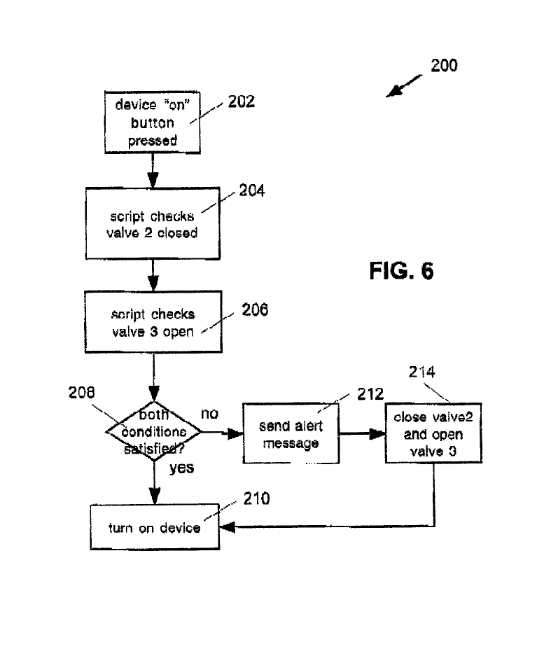

Referring now to FIGS. 2, 4, and 6, a flowchart of the INTERLOCK routine 200 which is executed by the internal microprocessor of PC 34 when interlock module 64 (FIG. 4) is utilized within control system 30 of FIG. 2, is specifically shown in FIG. 6. As is conventionally known in the manufacturing field, interlocks are used by control systems to provide safeguards against an operator doing something they are not supposed to. For example, it is not desirable to allow a furnace door to be opened when the furnace is at 2000° F., so an interlock is created to prevent the operator from opening the door. When the operator pushes the button to open the door, PC-based control system 30 will check to see if the temperature is below a safe value before allowing the door to open. If it is not then the door does not open and we can display a message telling the operator the furnace is too hot.

It should be noted that in PLC-based control system 10, ladder logic is used to check whether a number of conditions are present (i.e. the pump must be off, the valve closed and the heaters off in order for the door to open). It was desired to allow PC-based control system 30 to react at any point in the program when a operator tries to open a furnace door (or the like). In PC-based control system 30, it is contemplated that various routines would be operating at tho same time, and that it would be possible to jump back and forth from one sub-routine to another if desired. It is noteworthy that such a control scheme is not possible within ladder logic (i.e. associated with a PLC).

Interlocks generally use a series of “if” statements to check the status of the pertinent devices before allowing operation to continue. A combination of code and values in SCADA database blocks were used within interlock module 64 to implement proper Interlock operation. Specifically, at step (202), the device “on” button is pressed by the operator and the script then checks necessary operational conditions for allowing the device to be turned an (e.g. whether valve 2 is closed and valve 3 is open) at steps (204) and (200), respectively. It is determined using the appropriate SCADA program blocks whether both conditions are satisfied at step (208). If not then an alert message is sent to the operator at step (212) and optionally the necessary conditions for operation are established (e.g. valve 2 is closed and valve 3 is opened) at step (214). If the conditions are satisfied then at step (210) the device is turned on. Also, once the alerting process and/or the necessary operational conditions are established, the device is turned on at step (210).

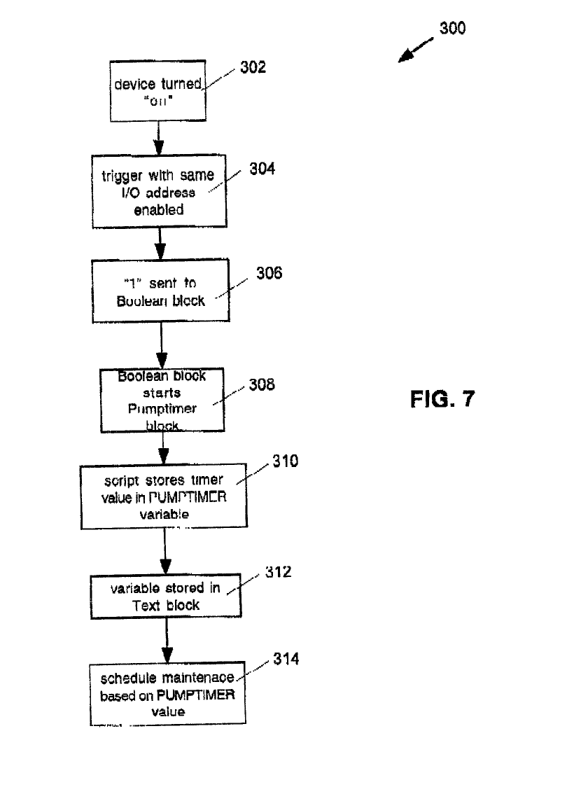

Referring now to FIGS. 2, 4, and 7, a flowchart of the MAINTENANCE routine 300 which is executed by the internal microprocessor of PC 34 when maintenance module 66 (FIG. 4) is utilized within control system 30 of FIG. 2, is specifically shown in FIG, 7.

For example, in order to record how long a device (e.g. a pump) has been operational the MAINTENANCE routine 300 must be executed. When the device is turned on at step (302), a trigger with the same I/O address is also turned on at step (304). The “1” value from the Pumptrigger (i.e. a DO block) is sent to a Boolean block at step (306), which then starts a PUMPTIMER SCADA database block at step (308). The PUMPTIMER database block then records the amount of time the pump is on. A script program takes this value from the database block and stores it in a PUMPTIMER variable at step (310). This variable is then sent to a Text block in the SCADA database for storage at step (312) for use in an operator display. Another script is used to compare this value to a preset value to determine whether maintenance can be scheduled at step (314).

In this way, run time counters can be constructed to tell how long a pump has been running and when it needs maintenance. Generally, this required setting up variables to check the status of some database blocks, triggering the timers and updating the variables with a now timing values. Timers elsewhere also need augmentation in order to save their values, which meant conducting certain file manipulation to periodically save data and to upload it to the database for operator information queries.

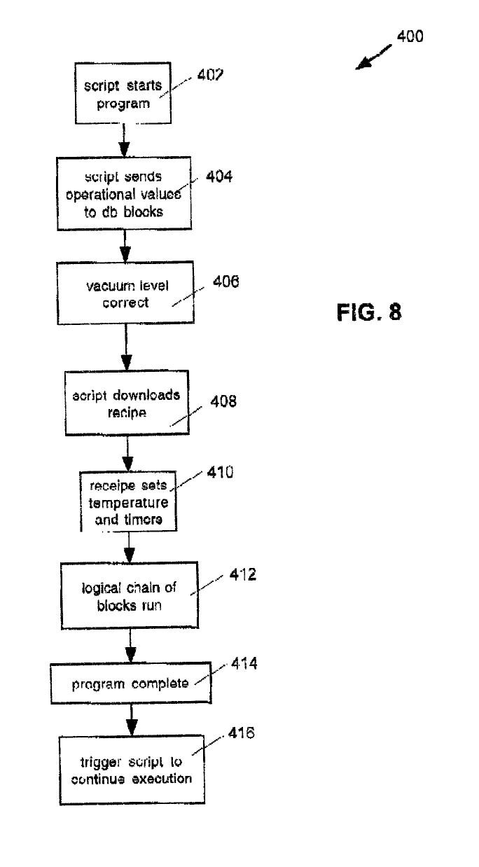

Referring now to FIGS. 2, 4, and 8, a flowchart of the PROGRAM routine 400 which is executed by the internal microprocessor of PC 34 when program module 68 (FIG. 4) is utilized within control system 30 of FIG. 2, is specifically shown in FIG. 8. In order for a manufacturing system (e.g. a furnace) to run a program, a set of checks must be run to confirm that the system is ready for operation. When the operator pushes the start button on the screen a script goes through all the interlock checks (an example of which was described in reference to the INTERLOCK routine 200 of FIG. 6) to make sure all pumps, valves, and the like etc. are “in the proper order” before starting. It they are not, a message appears on the screen to tell the operator what the problem is and how to remedy it.

Specifically, the script starts an operational program that is to be run on the manufacturing equipment at step (402). The script then starts sending operational values to the appropriate blocks in the database at step (404) to turn on pumps and cycle valves at the appropriate time, while comparing vacuum levels and times. When the vacuum level is determined to be correct at step (406), the scripts execute a command to download a pre-programmed recipe at step (408). As is conventionally known in the manufacturing field, the recipe sets the values for the temperature set point and timers in the database at step (410). The database then takes over and runs a logical chain of blocks at step (412) to control the furnace temperature and temperature of the load. The script waits until the database is finished running the program at step (414) from the recipe downloaded. Then a trigger starts the script to continue execution at step (416). At this point, it is also possible to dynamically set alarm values in certain database blocks based on the values downloaded from the recipe for additional functionality.

This procedure can be used in association with other parts of the furnace cycle. The script is executed and obtains data from the recipe, writes the data into the database and then uses a trigger to send control back to the script to continue to the next process. This can occurs a set number of times (e.g. four). As is conventionally, known, once for the Brazing part of he cycle, then to a Quench sequence, then for a Temper part of the cycle, then to do a Quench again, then finally the script finishes the program.

As discussed above, in order for PC-based control system 30 to run a preset program a combination of code, database blocks and recipes are used. The program starts in the script and then at the appropriate time downloads values from a stored recipe. This allows the form of the code to remain constant even though different values maybe downloaded from multiple recipes. Once the recipes are downloaded, the values are automatically put into the database. Logical chains in the database act on these values to perform different functions (e.g. temperature control, and cooling functions). Once any logical control from the database is accomplished, the script looks for triggers, such as the Quenchtrigger noted above, to continue in the code. This format is repeated in the code and is the basis for the control system. The database is constantly scanning the blocks and can be performing tasks at the same time as the script is running. This approach is useful when controlling the furnace because the system can be waiting for a critical value to be met in the code while the database in controlling the temperature through PID blocks. Since the code can be executed faster than the database scans, any interlocks written in the database could be bypassed simply because the code executed before the database had a chance to update. In order to remedy this, we had to transfer all of our interlock checks to the code that starts the program.

Finally, historical data collection is initiated during operation of the manufacturing machine. The script executes a command that starts the built-in History Recorder Program within the SCADA program and is assigns an operator provided file name. This way, every process run can be tracked by file name. These files are stored on the hard drive of PC 34 and the date and time are also associated with the file so that the History Display Program can open the appropriate file for display and analysis purposes.

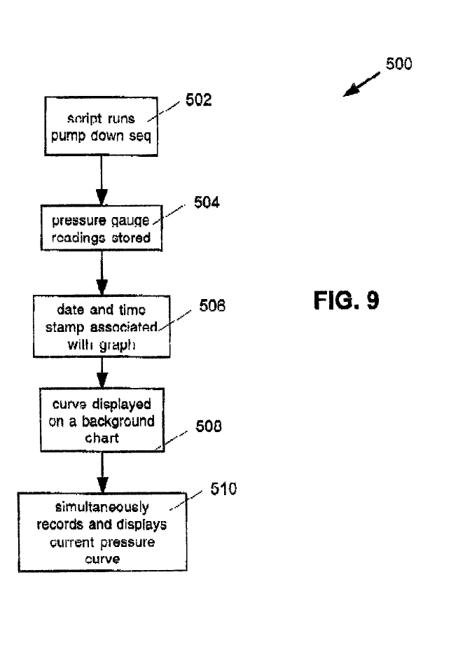

Referring now to FIGS. 2, 4, and 9, a flowchart of the DIAGNOSTIC routine 500 which is executed by the internal microprocessor of PC 34 when diagnostic module 70 (FIG. 4) is utilized within control system 30 of FIG. 2, is specifically shown in FIG. 9. The diagnostic module 70 uses the history collection and display functions of conventionally available SCADA program as well as original script, a few database blocks to hold some operational values (e.g. to run the pumps and valves).

Specifically, the program first runs a pump down sequence to bring the furnace under vacuum at step (502). It should be understood that this step could be generalized to bring any manufacturing machine or equipment to an operational state. The graph of all the different pressure gauge readings are stored in a file at step (504) in much the same way that the process runs are recorded (discussed above). A date and time stamp in associated with the graph at step (506) and the curve is then displayed on a background chart at step (508). A new chart is recorded and simultaneously displayed showing the current pressure curve (could be any other current diagnostic information) at step (510). Since date and time stamps are associated with the graphs, the operator is enabled to view two graphs simultaneously in order to compare a base line pressure curve to the current pressure curve. This diagnostic system allows the operator to run a comparison of the vacuum pumping performance of the system to a baseline curve generated at their point at choosing. This functionality is not currently possible within traditional control systems.

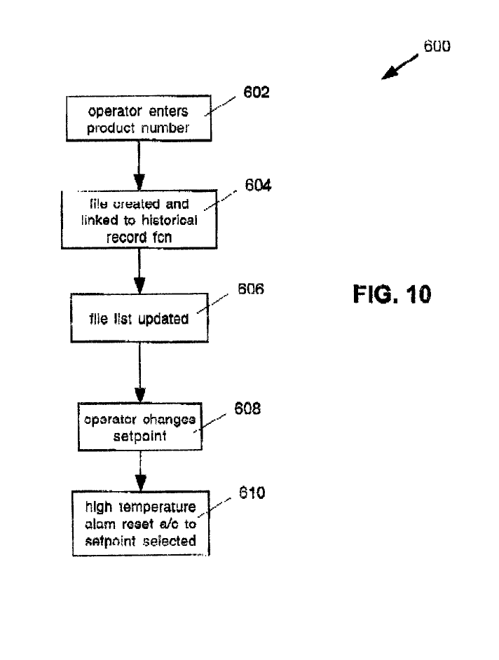

Referring now to FIGS. 2, 4, and 10, a flowchart of the HISTORICAL routine 600 which is executed by the Internal microprocessor of PC 34 when historical module 72 (FIG. 4) is utilized within control system 30 of FIG. 2, is specifically shown in FIG. 10. Control system 30 also tracks the cycle runs of the associated equipment using the customers' production numbers and can display a graph of the cycle using the build-in SCADA Historical Display program (e.g. Intellution's Historical Display program).

Specifically, a file is created when the operator enters the production number at step (602) and a file is created and linked to the historical recording function at stop (604). A list of the files is maintained and updated at step (606) within the SCADA database. This allows for relevant information to be displayed on display to the operator to show exactly what happened during the run based on a particular production number. During the process, the alarm and setpoints can be dynamically changed based on the input of the operator. For example, if the operator enters a particular setpoint (e.g. 100° F.) at step (608), then a high temperature alarm is automatically set at a predetermined value higher (e.g. at 110° F.). Subsequently, if the operator changes the setpoint to 150° F., then the high temperature alarm would be automatically set to 160° F. The predetermined value (i.e. the difference between the operator entered setpoint and the high temperature alarm) can also be adjusted within tho program as well.

It should be understood that the above-described routines are only examples of the kind of functionality that is contemplated within control system 30. For example, another contemplated feature would allow the control system 30 to switch between inputs if a thermocouple fails during a run. If as the process is running the thermocouple break (as commonly happens), the system could automatically transfer the measurement equipment to a backup thermocouple in order to keep the process running. Also with regard to maintenance, it is possible to implement a clean up cycle that needs to be run every 45 cycles (for example). For this application, the counter block is used to keep track or cycle runs and every 45 runs, a message is displayed to the operator indicating that it is time to run the clean up program. The operator has the choice of running the program or bypassing it to do one more production run before the clean up cycle. This bypass option will come up every time until the clean up cycle has finally be run and the counter starts counting to 45 again.

Within PC-based control system 30, control blocks, calculation blocks and program blocks can be treated entirely within the PC database to take real input values (i.e. values supplied by the I/O bank) and, through a calculation process or the operation of a subroutine, create a series of simulated I/O values which may be further processed by downstream calculation or program blocks to create ultimate real output values for return to the control system. In this way me SCADA database software permits realtime control of the physical system without the use of a PLC or ladder logic. Advantageously, by freeing the control system of ladder logic, the present invention permits a more sophisticated automated control, such as permitting control parameters to run within a range and allowing multiple inputs to be monitored and polled in response to a threshold condition, permitting a variety of control operations to be explored for a given threshold situation.

Prior PLC-based systems cannot provide such sophisticated control and allow for only rudimentary control. For example, if an input thermocouple reached a critical temperature, a PLC-based system could only effect a rudimentary result such as sending an alarm or shutting off a heater. Also, because PLC-systems are limited in the amount of inputs and outputs which can be monitored, due memory limitations in the PLC. As described, the present system permits a more sophisticated control such as gradually scaling back an output setting to permit the system to return to the control range, or to poll other system parameters to determine whether another system parameter is the cause of the particular event considered. Also, an almost infinite number of inputs and outputs can be monitored and controlled, the number being limited only by the amount of RAM memory available in the PC.

By eliminating the PLC, the control system of the present invention is able to incorporate the flexibility and power of PC-based applications in the operation and control of physical systems. With this flexibility, operations such as data logging, trending, reporting, control algorithms, monitoring, alarming, maintenance handling and error checking can be more easily affected. Diagnostics can be run on the physical devices to ensure reliable and functional operation of the system as a whole and/or each particular device. Data can be moved to other applications within the PC or microprocessor-based system for further processing. This permits the plethora of application software available for the PC platform to be used. Furthermore, by freeing the control system from the limitations of ladder logic, an increased degree of intelligence can be introduced to the control system to permit more advanced alarming and error handling and the like to permit the physical devices to operate within a range of process parameters rather than the binary on-off capability of the PLC-based systems. Programming can be provided, by way of control blocks, program blocks and scripting to allow a physical device to run within an operating range and, if the device moves to a condition outside of this range, the control system is able to affect changes in the operation of the physical system to bring the process back within the desired range without the aid of manual intervention, the capability not possible with current PLC-based systems.

Furthermore, by relocating control to the PC, the power of Internet applications, worldwide web technology and local and wide area networks are at the disposal of the programmer to be incorporated into the control system strategy. Furthermore, the programmer is able to call on a multitude of PC input and output devices, such as touch screen monitors, keyboard, mouse or voice-activated input devices and modem output devices to permit increased flexibility for operator interface with the PC-based control system. For example, connection of the PC controller to a network permits remote access to the PC from an external source and allows a remote operator to access the control system. This is highly advantageous in a global community where, for example, a control system running on one continent may be accessed in real time by personnel, such as system maintenance and support personnel at the equipment supplier, to access a customer's control system to troubleshoot problems or provide software updates, etc.

The present invention thus permits the proprietary hardware and software of the ladder logic-based PLC systems currently in use to be eliminated and permits the control system to conform to existing IT standards for communication to networks and other computer software packages currently in widespread use throughout the world. Furthermore, as increased computing power is added to PC platforms, the software is transferable and scalable to new PC platform as they become available. Accordingly, the programmer is no longer reliant upon the closed proprietary systems of PLC and equipment manufacturers.

Other features may be added to enhance operability and functionality of the control system. For example security features such as password protection and power interruption contingencies may be added.

As one skilled in the art will understand, an I/O bank is preferred but not necessary in the operation of the present system. For example, any physical device which is capable of sending and receiving an electronic signal may communicate directly with a properly configured microprocessor. In other words, driver software may be provided directly to the microprocessor to permit It to communicate directly with the physical device. Also, as mentioned above, the PLC used in an existing system may be modified to operate as an I/O bank. In such a system, the rungs of the prior-existing ladder logic control system of the PLC are deleted, leaving only the addressing information. When this is done, the PLC acts as a I/O bank and advantageously permits the upgrade of existing equipment currently using PLC control to be modified to employ the system of the present invention.

While the above description constitutes the preferred embodiment, it will be appreciated that the present invention is susceptible to modification and change without parting from the fair meaning of the proper scope of the accompanying claims.

1. A control system for controlling the operation of a machine comprising a plurality of devices, said control system comprising:
(a) a supervisory control and data acquisition (SCADA) program, said SCADA program including a plurality of program blocks and a plurality of database blocks;
(b) a supplemental program;
(c) a processor, wherein said processor is adapted to execute said SCADA program, wherein said processor is adapted to execute said supplemental program, and wherein said processor is adapted for controlling operation of the devices;
(d) a memory coupled to the processor for storing the SCADA program and the supplemental program;
(e) an input/output device coupled to the processor, for receiving and providing electrical signals directly to and from the devices; and
(f) said supplemental program enabling the processor to interoperate at least one program block of said SCADA program and at least one database block of said SCADA program, in response to electrical signals received from the devices, such that said processor can control the devices directly and without the need for an additional external control device.

2. The control system of claim 1, wherein said supplemental program causes said processor to interoperate said at least one SCADA program block with said at least one SCADA database block according to a predetermined timing schedule.

3. The control system of claim 1, wherein said supplemental program causes said processor to interoperate said at least one SCADA program block with said at least one SCADA database block in order to ensure that a predetermined set of interlock conditions are met by the devices.

4. The control system of claim 1 wherein said supplemental program causes said processor to interoperate said at least one SCADA program block with said at least one SCADA database block in order to provide an alerting signal when the devices satisfy a predetermined set of maintenance conditions.

5. The control system of claim 1, wherein said supplemental program causes said processor to interoperate said at least one SCADA program block with said at least one SCADA database block in order to run an operational program in association with the devices.

6. The control system of claim 1, wherein said supplemental program causes said processor to interoperate said at least one SCADA program block with said at least one SCADA database block in order to run an set of diagnostic routines for the devices.

7. The control system of claim 1, wherein said supplemental program causes said processor to interoperate said at least one SCADA program block with said at least one SCADA database block in order to obtain and display a set of historical data associated with the devices.

8. A method of controlling a machine comprising a plurality of devices using a control system that includes a processor that executes a supervisory control and data acquisition (SCADA) program which includes a plurality of program blocks and a plurality of database blocks, said method comprising the steps of:
(a) receiving electrical signals from at least one of the devices;
(b) interoperating at least one program block of said SCADA program with at least SCADA database block in response to the electrical signals received from the devices using a supplemental program stored with the SCADA program,
(c) providing electrical signals to the devices that correspond to the output of the at least one SCADA program block such that the devices can be controlled directly and without the need for an additional external control device.

9. The method of claim 8, wherein step (b) further comprises interoperating the at least one program block of said SCADA program with at least SCADA database block according to a predetermined timing schedule.

10. The method of claim 8, wherein step (b) further comprises interoperating the at least one program block of said SCADA program with at least SCADA database block to ensure that a predetermined set of interlock conditions are met by the devices.

11. The method of claim 8, wherein step (b) further comprises interoperating the at least one program block of said SCADA program with at least SCADA database block to provide an alerting signal when the devices satisfy a predetermined set at maintenance conditions.

12. The method of claim 8, wherein step (b) further comprises interoperating the at least one program block of said SCADA program with at least SCADA database block in order to run an operational program in association with the devices.

13. The method of claim 8, wherein step (b) further comprises interoperating the at least one program block of said SCADA program with at least SCADA database block in order to run an set of diagnostic routines for the devices.

14. The method of claim 8, wherein step (b) further comprises interoperating the at least one program block of said SCADA program with at least SCADA database block in order to obtain and display a set of historical data associated with the devices.
